(19) United States
(12) Patent Application Publication
(10) Pub. No.: US 2017/0232536 A1
(43) Pub. Date: Aug. 17, 2017

(54) PROTECTIVE COVER WITH COOLING FOR CUTTER DISCS

(71) Applicant: GERMANS BOADA, SA, RUBI (BARCELONA) (ES)

(72) Inventor: DANIEL RODRIGUEZ RODRIGUEZ, RUBI (ES)

(73) Assignee: Daniel RODRIGUEZ

(21) Appl. No.: 15/431,999

(22) Filed: Feb. 14, 2017

(30) Foreign Application Priority Data
Feb. 17, 2016 (ES) P201630180

(51) Int. Cl. B23D 59/02

(52) U.S. Cl. CPC B23D 59/02

(57) ABSTRACT

Protective cover with cooling for cutter discs; which comprises a generally semi-cylindrical cavity (15) that covers a portion of the cutting disc (2) at the top and that is delimited by two lateral walls (11, 12) and a curved perimeter wall (13). Said cavity (15) internally comprises, in its periphery, fastening means (16, 17) for a tube (3) and a cooling liquid supply nozzle (31) for the disc (2) in at least one upper position (P1) in which the nozzle (31) pours the liquid on the upper end of the disc (2), and one lower position (P5) in which the nozzle (31) sprays the liquid directly against the edge of the disc (2).

### OBJECT OF THE INVENTION

The object of the invention is a protective cover with cooling for cutter discs, which may be coupled to the casing of a cutter and which comprises a generally semi-cylindrical cavity that covers a portion of the cutting disc at the top, and that is delimited by two lateral walls provided with facing extensions that make up a curved perimeter wall.

This cover has characteristics intended to enable the positioning of a tube with a nozzle in several positions to dispense the cooling liquid on the disc and to redirect the water sprayed by said disc during its rotation movement towards the cutting disc.

### FIELD OF APPLICATION OF THE INVENTION

This invention is applicable in disc cutters and especially, although by no means limited to, in cutters for construction materials.

### STATE OF THE ART

Currently, disc cutters that comprise a cutting disc actuated by a motor, and provided with a protective cover or lid which defines a cavity with a generally semi-cylindrical configuration intended to cover a portion of the periphery of the disc for safety reasons, leaving a portion of the disc uncovered in a cutting area, are widely known.

The incorporation of cooling means for the disc in this type of cutters is also known, consisting in a supply tube for a cooling liquid, usually water, which pours said cooling liquid on an area of the lateral surface of the disc close to its periphery.

In the known prior art of cutters, this tube is maintained in a fixed position with respect to the disc, the disc cooling varying significantly depending on the available flow rate of liquid, which could cause said cooling to become insufficient.

Another disadvantage of these cooling means is that the cooling liquid that comes into contact with the disc is rapidly sprayed against a curved perimeter wall of the cover, due to the centrifugal force created as the cutting disc rotates; the cooling liquid leaving the inner cavity of the cover practically without touching the disc and consequently creating significant waste in the cooling capacity of the liquid used.

### DESCRIPTION OF THE INVENTION

The protective cover with cooling for cutter discs; comprising a generally semi-cylindrical cavity that covers a portion of the cutting disc at the top, and which is delimited by two lateral walls and a perimeter wall; it has construction peculiarities aimed at satisfactorily resolving the problem set forth, and more specifically, enabling the arrangement of the tube and the cooling liquid dispensing nozzle in different positions with respect to the cutting disc; and enabling reuse, in the cooling of the disc, of the liquid sprayed as the disc rotates, before it leaves the cavity of the cover.

To achieve said objectives, the cavity of the cover internally comprises, in its periphery, fastening means for a tube and a cooling liquid supply nozzle for the disc in at least one upper position in which the nozzle pours the liquid on the upper end of the disc, and one lower position in which the nozzle sprays the liquid directly against the edge of the disc. The studies carried out have confirmed that the disc cools better in situations with a low flow rate if the water is sprayed from above, and in situations with a high flow rate if the water is sprayed in a horizontal position, thus the mentioned characteristic enables the disc cooling to be optimized by varying the position of the nozzle depending on the available flow, between: an upper position from which the liquid is poured on the upper area of the disc when there is a low flow rate, and a lower position when there is a higher flow rate of cooling liquid.

Another relevant characteristic of the invention is that the lateral walls of the cover internally comprise flaps for collecting, and for redirecting towards the lateral faces of the disc the liquid sprayed by the cutting disc during its rotation movement. These flaps enable the liquid sprayed by the disc against the perimeter wall of the cover to be reused to cool the disc before said liquid leaves the cavity of the cover; optimizing the use of said liquid.

The aforementioned characteristics and other characteristics of the invention described in the attached claims will be more easily understood in light of the exemplary embodiment shown by way of illustration and not limitation in the attached figures that are described below.

### DESCRIPTION OF THE FIGURES

FIG. 1 shows a front elevation view of the protective cover with cooling for cutter discs.

FIG. 2 shows a front elevation view of the protective cover with cooling for cutter discs.

FIG. 3 shows a front elevation view of the protective cover, in which one of the lateral walls has been removed in order to allow a view of the tube and the cooling liquid supply nozzle, said nozzle being represented using solid lines in the upper position and dotted lines in a lower position.

FIG. 4 shows a perspective view of one of the lateral walls of the cover seen from its inner face.

FIG. 5 shows a profile view of a vertical cross-section of an upper portion of the cover and the disc.

### PREFERRED EMBODIMENT OF THE INVENTION

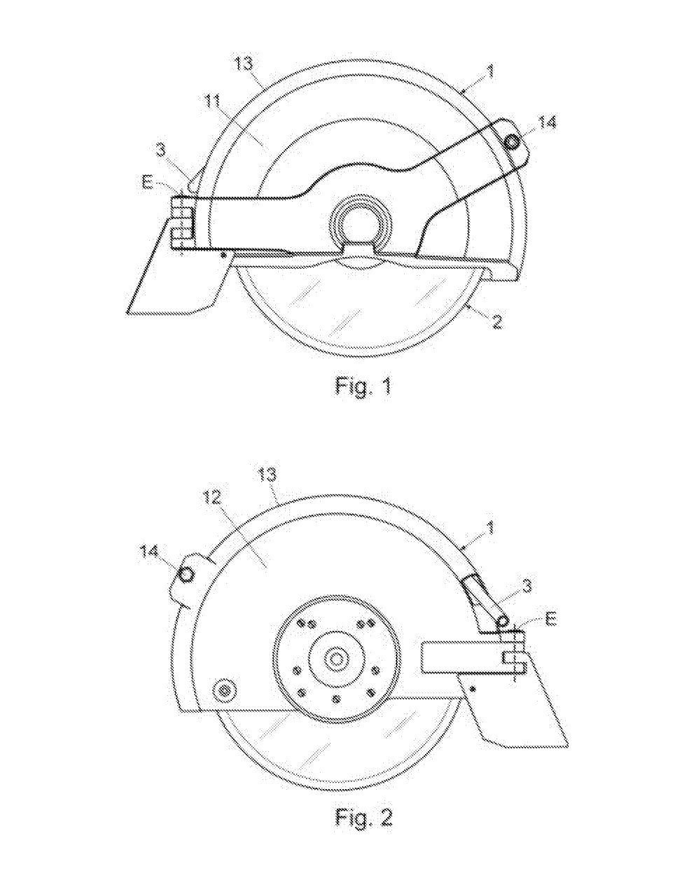

In FIGS. 1 and 2, the protective cover (1) with cooling for cutter discs is seen; which comprises two lateral walls (11, 12) provided with facing extensions that make up a curved perimeter wall (13). Said cover (1) covers a portion of the cutting disc (2) at the top.

The lateral walls (11, 12) are connected to each other via a rotating shaft (E) that enables the cover (1) to be opened, and they are fixed in a closed position via a threaded element (14).

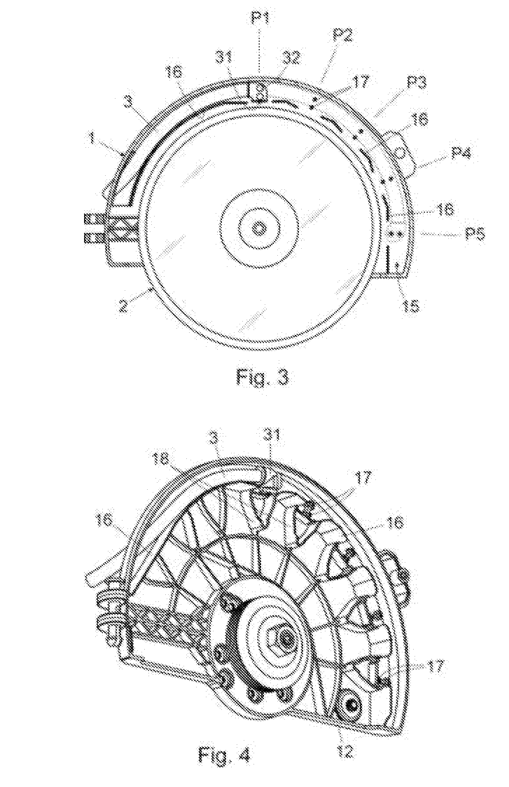

In the closed position, the cover (1) defines an inner cavity (15) that internally comprises, in its periphery, fastening means for a tube (3) and a cooling liquid supply nozzle (31) for the disc (2) in several positions (P1, P2, P3, P4, P5) shown in FIG. 3, comprised between: an upper position (P1) in which the nozzle pours the liquid vertically on the upper end of the disc (2), and a lower position (P5) in which the nozzle (31) sprays the liquid directly, in this case horizontally, against the edge of the disc (2). The intermediate positions (P2, P3 and P4) are uniformly distributed between the upper and lower end positions (P1, P5).

The fastening means for the tube (3) comprise guides (16) parallel to the curved perimeter wall (13) and that define, together with said perimeter wall (13), a passage for the tube housing (3). The fastening means for the nozzle (3) comprise attachments (17) and complementary coupling housings (32) defined inside the cover (1) and in the nozzle (31).

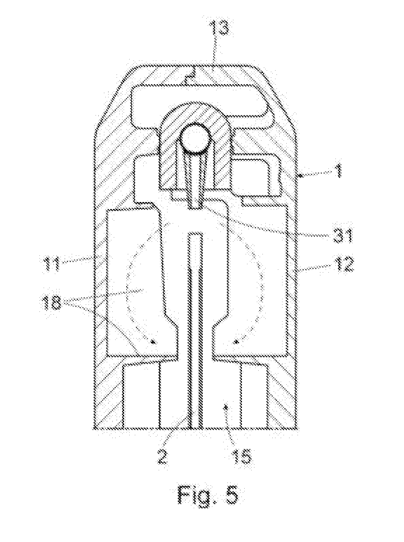

As seen in FIGS. 4 and 5, the lateral walls (11, 12) of the cover internally comprise flaps (18) for collecting, and for redirecting towards the lateral faces of the disc (2) the liquid sprayed towards the perimeter wall (13) by the cutting disc (2) itself during its rotation movement due to the centrifugal force.

Having sufficiently described the nature of the invention, in addition to a preferred exemplary embodiment, it is hereby stated for the relevant purposes that the materials, shape, size and layout of the described elements may be modified, provided that it does not imply altering the essential characteristics of the invention claimed below.

1. A protective cover with cooling for a cutter disc having an top upper portion, a lower portion and an edge, whereby said cover comprises a generally semi-cylindrical cavity that covers a portion of a cutting disc about its top and is delimited by two lateral walls and a curved perimeter wall whereby said cavity internally comprises, in its periphery, fastening means for a tube and a cooling liquid supply nozzle that has at least one upper position in which the nozzle directs a cooling liquid about an upper portion of the disc, and a lower position in which the nozzle directs a cooling liquid towards the edge of the disc.

2. The cover, according to claim 1, characterized in that the lateral walls of the cover internally comprise flaps for collecting and redirecting towards the lateral faces of the disc, liquid sprayed by said disc towards the perimeter wall during its rotation movement.

3. The cover, according to claim 1, characterized in that the fastening means for the tube comprise guides parallel to the perimeter wall and that define, together with said perimeter wall, a passage for the tube.

4. The cover, according to claim 1, characterized in that the fastening means for the nozzle comprise attachments and complementary coupling housings defined inside the cover and nozzle in order to fasten the nozzle in several positions between the upper position and the lower position.

5. The cover, according to claim 4, characterized in that the attachments defined inside the cover are distributed angularly between the upper and lower positions.
